(19) United States
(12) Patent Application Publication
(10) Pub. No.: US 2023/0261611 A1
(43) Pub. Date: Aug. 17, 2023

(54) Photovaltaic Module and Connection Socket for a Photovoltaic Module

(71) Applicant: Weidmüller Interface GmbH & Co. KG, Detmold (DE)

(72) Inventors: Matthias BÖNSCH, Bielefeld (DE); Torsten WÜNSCHE, Leopoldshöhe (DE); Torsten JUNG, Horn-Bad Meinberg (DE); Christopher SMITH, Steinhagen (DE); Torsten DIEKMANN, Leopoldshöhe (DE)

(21) Appl. No.: 18/168,858

(22) Filed: Feb. 14, 2023

(30) Foreign Application Priority Data
Feb. 15, 2022 (DE) 102022103543.3

(51) Int. Cl. H02S 40/34; H02S 20/00

(52) U.S. Cl. CPC H02S 40/34; H02S 20/00

(57) ABSTRACT

A photovoltaic module includes at least two cell assemblies externally contactable at connecting contacts, which are arranged linearly at the rear side of the photovoltaic module in groups of two connecting contacts which are allocated to the cell assemblies. One connection socket is arranged on a rear side of the photovoltaic module, this connection socket having a housing which has at least one rear opening for passing the connecting contact through, wherein the housing covers all connecting contacts of the photovoltaic module. In a connection socket for such a photovoltaic module, the housing has an elongated shape, wherein all connecting contacts are arranged in a line along a longitudinal direction of the housing.

This application claims priority of DE 10 2022 103 543.3 filed on Feb. 15, 2022, the entire content of which is incorporated herein by reference.

### BACKGROUND OF THE INVENTION

The invention relates to a photovoltaic module with at least two cell assemblies, which are externally contactable at connecting contacts, which are arranged linearly on the rear side of the photovoltaic module in groups of two connecting contacts which are allocated to the cell assemblies. The invention furthermore relates to a connection socket for such a photovoltaic module, wherein the connection socket has a housing which has at least one opening for passing the connecting contact through, and wherein at least four contacts for contacting the connecting contacts are arranged in the housing.

Photovoltaic modules, hereafter also abbreviated to PV modules, e.g. for mounting on a house roof or in ground-mounted facilities, generally have a number of photovoltaic cells (PV cells) which, connected in series and/or in parallel, form at least one cell assembly which is externally contactable via power cables. PV modules frequently have several such cell assemblies which are interconnected in series inside the PV module. In this case, each of the cell assemblies is usually guided out of the module by its end connections, in order to connect one so-called “bypass diode” in parallel to each cell assembly. The bypass diodes conduct current past shadowed or faulty cell assemblies. Without the bypass diodes, shadowing or a fault of one of the cell assemblies of the module would reduce the flow of current through the entire module, even if the other cell assemblies of the module or even other additional modules connected in series with the module are not in shadow or faulty.

### BRIEF DESCRIPTION OF THE PRIOR ART

From the prior art, PV modules are known in which connecting contacts of the present cell assemblies (usually of three cell assemblies) are contactable adjacent to one another at a rear side of the PV module in a common connection region.

A PV module with such a connection assembly is described in document US 2016/0141435 A1, for example. In a further embodiment, the document describes a PV module in which contact surfaces of various cell assemblies are not positioned in a common connection region on the rear side of the PV module, but rather at several different positions. Such a layout of a PV module is implemented in particular if the PV module has two row assemblies connected in parallel (so-called strings) of PV cells at two connecting contacts. Two strings connected in parallel can be integrated geometrically into a rectangular PV module, by positioning the common connecting contacts along a centerline which runs centrally with regard to a direction of longitudinal extent of the PV module and thus parallel to the shorter transverse sides of the PV module. For example, if the PV module has three cell assemblies which are contactable independently of one another, then there are three sets of two contacts, which are adjacent to one another and arranged along this centerline. In this case, a set of two connecting contacts is positioned approximately centrally along the centerline and each of the other two sets of contacts is positioned on one and the other side, respectively, closer to the longitudinal side of the PV module. Each of the connection regions is covered by a socket which receives a bypass diode. At least two of the sockets function, as described previously, as connection sockets by a power cable leading to each of these sockets for the external connection of the PV module and being connected to one of the cell assemblies inside the socket.

The employment of several separate sockets for each cell assembly leads to increased outlay when putting up and, if necessary, sealing the sockets or connection sockets.

### SUMMARY OF THE INVENTION

An objective of the present invention is to provide a connection socket for a photovoltaic module in which there is less mounting outlay even in the case of modules in which the contacts of various cell assemblies are not guided out of the PV module adjacent to one another.

A photovoltaic module according to the invention is characterized in that one connection socket is arranged on a rear side of the photovoltaic module, this connection socket having a housing which has toward its rear side at least one opening for passing the connecting contacts through, wherein the housing covers all connecting contacts of the photovoltaic module.

With an appropriate design of the housing of the connection socket, even with a PV module in which the connecting contacts of the cell assemblies are not positioned in a common connection region on the rear side of the PV, it is possible and advantageous to cover the connecting contacts by one single connection socket and to contact them inside the connection socket. Accordingly, this requires a connection socket only be arranged onto the rear side of the PV module, which simplifies and accelerates contacting and thus the production of the PV module.

Furthermore, due to its length, the connection socket represents a strengthening and stabilization of the PV module. Through the stabilization by the connection socket, the PV module can bear a greater load, for example from snow or wind. With regard to manufacturing efficiencies, including transporting and mounting the PV modules, larger PV modules are advantageous. Strengthening and stabilizing the modules is thus more important the larger the dimensions of PV modules become. The stabilization by the connection socket which extends over all connecting contacts thus supports the manufacturability of larger PV modules. Alongside the positive stabilizing and strengthening characteristics, greater rigidity of the PV module is also advantageous for production, transport and handling during mounting.

In one configuration, the PV module has a rectangular surface area, wherein the line along which the connecting contacts are arranged runs parallel to one of the side edges of the photovoltaic module and wherein the housing of the connection socket has a length which is greater than 50%, and preferably greater than 66%, of the length of the side edge. With the specified housing sizes, it is possible to cover the connecting contacts of PV modules with two or three independent cell assemblies. The connection sockets thus have a length amounting to a significant part of the width of the PV module, which gives rise to a greater strengthening effect. The line along which the connecting contacts are situated preferably runs approximately centrally on the rear side of the PV module. In this position, support for the layered stacks of the PV module is particularly effective.

In a further configuration, the PV module has an outer frame made of metal profiles, wherein at least one and preferably both of the housing connection socket ends extend to the frame. In this case, to further increase the strengthening effect, the connection socket is lengthened over the length required to cover the connecting contacts of the PV module, up to the frame and thus the edge of the PV module.

In a further configuration of the PV module, the housing of the connection socket has an underside which serves as a gluing surface by which the connection socket is glued onto the rear side. The longitudinal extent of the housing makes it possible to use a relatively large gluing surface, which leads to a substantial loading capacity of the connection between the connection socket and the rear side of the PV module. For example, it is thus possible to prevent tractive forces on a power cable, which is connected to the connection socket, from inadvertently releasing the connection socket from the rear side.

The connection socket for a photovoltaic module includes a housing that has an elongated shape, wherein all connecting contacts are arranged in a line along a longitudinal direction of the housing. Through this configuration of the housing, all connecting contacts of PV modules of this design can be contacted inside a connection socket. There arise the advantages described in relation to the PV module.

In a configuration of the connection socket, the contacts are arranged in contact regions in the housing. The housing can also have, in each of the contact regions, an opening upwards which can be closed with a cover. A housing cavity can be hermitically sealed by the cover such that it is not necessary to cast the cavity. The contact regions then advantageously remain accessible by opening the cover and would also be simpler to separate in the event of recycling.

In a further configuration, the connection socket has at least one contact bearer which includes at least two contacts for contacting the connecting contacts of the PV module. The contact bearer can be formed by a lead frame. It is also conceivable that the contact bearer includes all contacts for contacting the connecting contacts, i.e. it extends through the housing over all contact regions. Tulip contacts, for example, can be used as the contacts. Furthermore, at least one bypass diode, which is connected in parallel to two contacts, can be arranged at the contact bearer. The bypass diodes can be easily exchanged via the access to the contact bearer through the cover if a fault arises in one of the bypass diodes.

### BRIEF DESCRIPTION OF THE DRAWINGS

The invention will be explained in greater detail below using embodiments with the aid of the accompanying figures in which:

FIG. 1a is a rear perspective view of a PV module;

FIG. 1b is a detailed perspective view of the connection socket region of the PV module from FIG. 1a;

FIG. 2a is a rear perspective view of a second embodiment of a PV module;

FIG. 2b is a detailed perspective view of the connection socket region of the PV module from FIG. 2a;

FIG. 2c is a perspective view of the underside of the connection socket of FIGS. 2a and 2b;

FIG. 3a is a perspective view of a connection socket of a PV module when disconnected;

FIG. 3b is a perspective view of the contact element of FIG. 3a; and

FIG. 3c is a perspective view of the assembly of FIG. 3a when connected.

### DETAILED DESCRIPTION

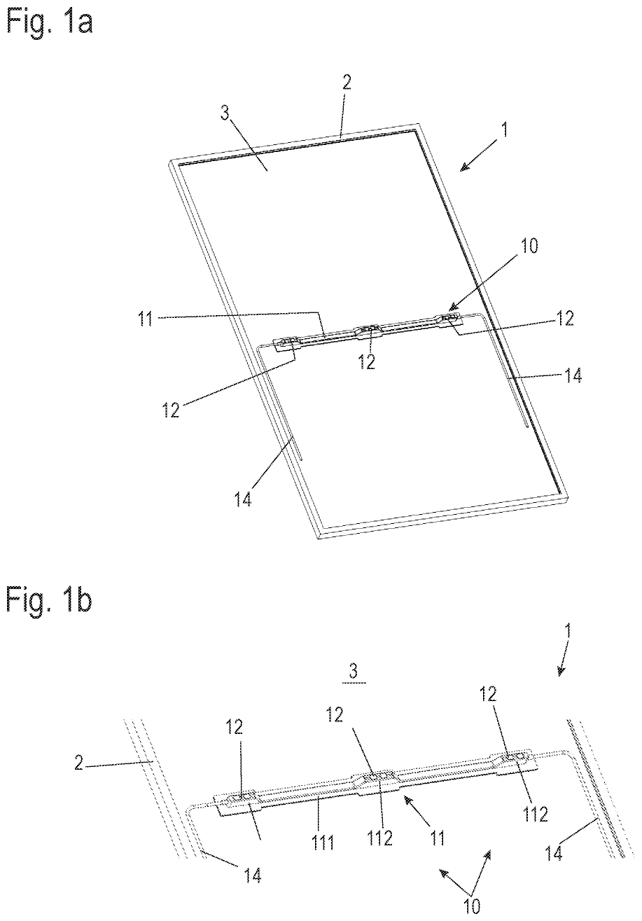

FIG. 1a shows a PV module 1 in an isometric depiction. The PV module 1 has a frame 2 and module structure which is referred to as the layered design or layer stack. A rear side 3 of this module structure can be seen in FIG. 1a.

In the PV module 1, the module structure includes one or more cell assemblies—specifically three in this example—which each have a number of PV cells which cannot be seen individually and which in each case are arranged in the form of two strings. The rear side 3 of the PV module 1 is covered by an isolating layer which is removed at selected locations in order to enable the exit of connecting contacts of the cell assemblies.

The PV module 1 from FIG. 1a includes connecting contacts that are arranged in groups of two contacts each per cell assembly along a centerline of the PV module 1. The centerline of the PV module 1 runs parallel to its shorter sides and centrally with regard to the longer sides of the PV module 1, which has a rectangular surface area.

Along the centerline, there is a connection assembly 10 which is shown in an enlargement in FIG. 1b. The connection assembly 10 includes a connection socket 11 and two power cables 14.

The connection socket 11 extends over approximately the entire width of the PV module 1, such that all connecting contacts of the PV module 1 are covered by a single connection socket 11 and are appropriately contacted inside the connection socket 11. The connection socket 11 accordingly has a continuous and elongated housing 111. This housing 111 is widened and heightened in three contact regions 112 in which the connecting contacts—not shown in this example—of the PV module 1 are situated. Each contact region is covered by a cover 12.

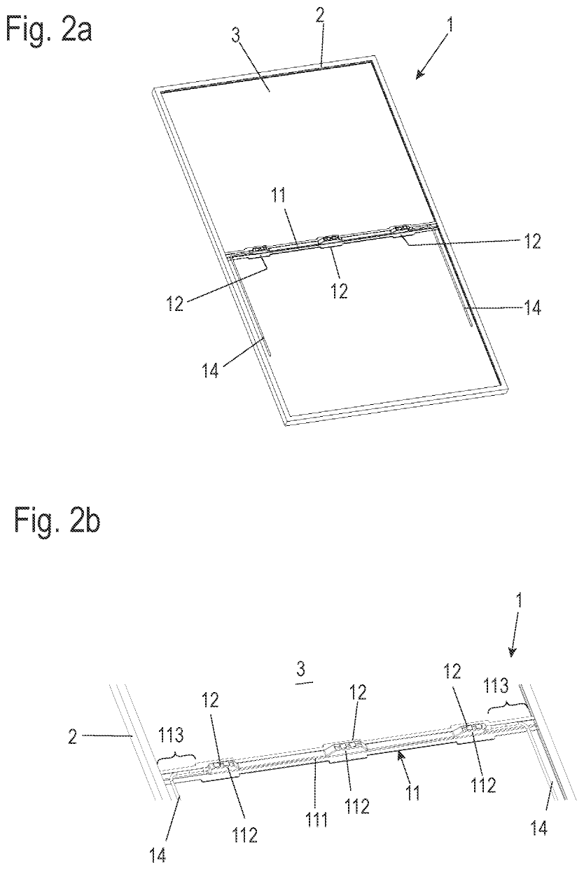

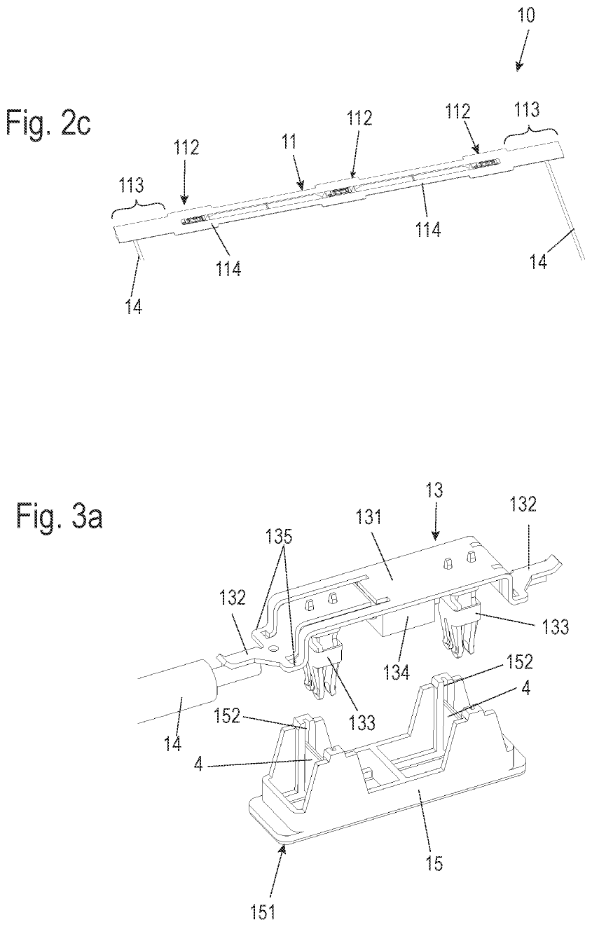

In FIGS. 2a and 2b, a further embodiment of a PV module 1 with a connection assembly 10 is depicted. The design of the PV module 1 and of the connection assembly 10 substantially corresponds to that of the first embodiment of FIGS. 1a and 1b. In contrast, as can be seen in particular from FIG. 2b, the connection socket 11 extends beyond the two outer contact regions 112 and lengthened end sections 113 extend to the frame 2 of the PV module 1.

In both embodiments, the elongated connection socket 11 with the appropriately formed housing 111 makes it possible to contact all connecting contacts of the PV module 1 through a single connection socket 11. Accordingly it is necessary to mount only this one connection socket 11 onto the rear side 3 of the PV module 1. This accelerates the contacting and thus the manufacture of the PV module 1.

Furthermore, whether the connection socket 11 extends over a portion of the width of the PV module 1 (FIG. 1a, 1b) or over the entire width of the PV module 1 (FIG. 2a, 2b), it strengthens and stabilizes the PV module 1. Through the stabilization by the connection socket 11, the PV module 1 can bear a greater snow or wind load, for example. Alongside the positive stabilizing and strengthening characteristics in operation, greater rigidity of the PV module 1 is also advantageous for production, transport and handling during mounting.

FIG. 2c depicts a rear side view of the connection assembly 10, i.e. the assembly made up of the connection socket 11 and power cables 14, separately from the PV module 1. This depiction shows that the housing 111 provides, on its underside 114, a large gluing surface with which the connection socket 11 is glued and sealed onto the rear side 3 of the PV module 1. The large gluing surface also gives rise to a substantial loading capacity of the connection between the connection socket 11 and the rear side 3 of the PV module 1, which prevents, for example, tractive forces on the power cable 14 from inadvertently releasing the connection socket 11 from the rear side 3 of the PV module 1.

Furthermore, it can be seen in FIG. 2c that the housing 111 contains a continuous cavity extending over the three contact regions 112. If contact of the cell assemblies to one another is not performed inside the PV module 1, the cavity present between two contact regions 112 in the housing 111 can be used to implement an electrical connection between the connecting contacts of the various cell assemblies inside the connection socket 11.

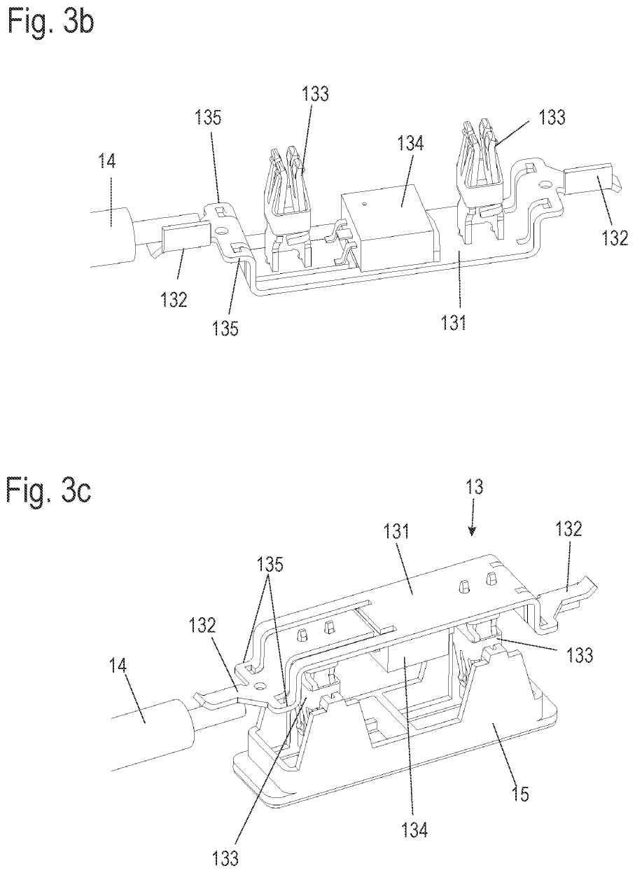

FIGS. 3a-3c show the region of two connecting contacts 4 on the rear side 3 of a PV module 1.

In FIG. 3a, the two connecting contacts 4 of a cell assembly extend outwardly from the rear side 3 of the PV module 1 in the form of connection lugs. Via the connecting contacts 4, a contact bearer 15 is glued by its underside 151 onto the rear side 3 of the PV module 1. The contact bearer 15 has, in the region of the connecting contacts 4, contact guide grooves 152 which guide the connecting contacts 4 and prevent deflection of the connecting contacts 4 to the side.

In the depicted embodiment, one contact bearer 15 is provided for every two connecting contacts 4. In the PV modules 1 shown in FIGS. 1a to 2c, three contact bearers 15 have been employed, corresponding to the number of three cell assemblies. In alternative designs, it is also possible to have a single contact bearer which extends over the connection regions of all cell assemblies and receives all connecting contacts 4 of the PV module 1, e.g. through an appropriate number of contact guide grooves 152.

The housing 111 of the connection socket 11 is then placed onto the contact bearer(s) 15, with the housing 111 fully surrounding the contact bearers 15. The underside 114 of the housing 111, as shown in FIG. 2c, is glued to the rear side 3 of the PV module 1.

One contact element 13 for each pair of connecting contacts 4, which is already inserted into the housing 111, is provided to contact the connecting contacts 4 of a cell assembly. FIG. 3a depicts such a contact element 13 before placement onto the connecting contacts 4 or the contact bearer 15. The housing 111 of the connection socket 11 is not shown in this example, so that the contact bearer 15 and the contact element 13 are visible.

The contact element 13 in this example is configured as a lead frame 131. Connections 132 are configured laterally on the lead frame 131, with one of the power cables 14 being affixed to one of the connections 132, for example in a spot-welding process. A power cable which leads to the next contact region 112 can be connected to the opposite connection 132. If internal contacting between the cell assemblies is provided in the PV module 1, the second connection 132 can remain open.

Furthermore, two contacts for contacting the connecting contacts 4, which in the present case are designed as tulip contacts 133, are provided on the contact element 13. In addition, a bypass diode 134 is mounted thereon, which is electrically connected between the two tulip contacts 133, such that it is connected in parallel to the connecting contacts 4 and thus in parallel to the cell assembly.

FIG. 3b separately shows the contact element 13 with a view of its underside. In order to mount the tulip contacts 133 and the bypass diode 134 on the lead frame 131, in particular to be able to weld or solder them, the lead frame 131 is provided in one piece. The lateral connections 132 are therefore at first electrically connected to one another. After the tulip contacts 133 and the bypass diode 134 have been mounted, this connection is disconnected at separation locations 135.

Affixing the mounted contact elements 13 in the connection socket 11 can be carried out by latching elements in the housing 111 of the connection socket 11. Alternatively or in addition, hot-stamped retaining elements of the housing 111 can be used. In this case, it is conceivable that the separation locations 135 are opened in one step with hot stamping.

FIG. 3c depicts the assembly from FIG. 3a in which the contact element 13 is pressed onto the connecting contacts 4, such that the tulip contacts 133 contact the connecting contacts 4.

As previously described, the contact elements 13 are preferably already integrated into the connection socket 11. Alternatively, it is also possible to place the contact elements 13, as shown in FIG. 3c, onto the contact bearers 15 at first without a connection socket and then put the connection socket 11 on.

In any case, by gluing the connection socket 11 by its underside 114 onto the rear side 3 of the PV module 1 and enclosing the contact regions 112 via the cover 12, the cavity formed in the housing 111 of the connection socket 11 is hermetically sealed such that it is not necessary to cast the cavity. Advantageously, by opening the cover 12, the contact element 13 can be exchanged, for example when a fault has arisen in the relevant bypass diode 134. If an exchange of elements is not envisaged, the cover 12 can be integrally configured with the connection socket 11, i.e. the connection socket 11 can be fully closed with the exception of the opening on its underside 114.

1. A photovoltaic module, comprising:
at least two cell assemblies externally contactable at connecting contacts which are arranged linearly at a rear side of the photovoltaic module in groups of two for each cell assembly; and
one connection socket being arranged on a rear side of the photovoltaic module and including a housing which contains at least one rear side opening for passing a connecting contact through, wherein said housing covers all connecting contacts of the photovoltaic module.

2. The photovoltaic module according to claim 1, and further comprising a rectangular surface area, wherein a line along which said connecting contacts are arranged is parallel to a side edge of the photovoltaic module and wherein said housing of the connection socket has a length greater than one of 66% and 80% of a length of said side edge.

3. The photovoltaic module according to claim 2, and further comprising a metal outer frame, wherein at least one end section of said connection socket housing extends to a side of said frame.

4. The photovoltaic module according to claim 3, wherein two ends of said connection socket housing extend to respective sides of said frame.

5. The photovoltaic module according to claim 1, wherein said housing has an underside surface by which the connection socket is glued onto said photovoltaic module rear side.

6. A connection socket for a photovoltaic module, comprising:
at least two cell assemblies externally contactable at least two connecting contacts; and
a housing which contains at least one opening for receiving a connecting contact and wherein at least four contacts for contacting the connecting contacts are arranged, said housing having an elongated shape, wherein all connecting contacts are linearly arranged along a longitudinal direction of the housing.

7. The connection socket according to claim 6, wherein said contacts are arranged in contact regions of said housing.

8. The connection socket according to claim 7, wherein said housing contact regions contain upward openings configured to receive a cover.

9. The connection socket according to claim 6, and further comprising at least one contact bearer which bears at least two contacts.

10. The connection socket according to claim 9, wherein said at least one contact bearer is formed by a lead frame.

11. The connection socket according to claim 10, wherein said at least one contact bearer bears all contacts for contacting said connecting contacts.

12. The connection socket according to claim 6, wherein said contacts are tulip contacts.

13. The connection socket according to claim 9, and further comprising at least one bypass diode connected in parallel to two contacts and arranged at the at least one contact bearer.
